(19) United States
(12) Patent Application Publication
(10) Pub. No.: US 2025/0233396 A1
(43) Pub. Date: Jul. 17, 2025

(54) CLIPS

(71) Applicant: DAIWA KASEI INDUSTRY CO., LTD., Okazaki-shi (JP)

(72) Inventors: Makoto KATO, Toyota-shi (JP); Ryo KONDO, Ozazaki-shi (JP); Kiyohiro YOSHIHASHI, Toyota-shi (JP)

(21) Appl. No.: 19/015,284

(22) Filed: Jan. 9, 2025

(30) Foreign Application Priority Data
Jan. 12, 2024 (JP) 2024-003104
Dec. 6, 2024 (JP) 2024-213148

(51) Int. Cl. H02G 3/32

(52) U.S. Cl. CPC H02G 3/32

(57) ABSTRACT

A clip configured to hold an elongated conductor bar may include a structurally rigidified base, a first side wall and a second side wall vertically extending upward from the base and having an upper opening, a receiving space defined by the base, the first side wall and the second side wall, and a retainer strip formed in an upper end of the second side wall. The first side wall includes a guide portion formed in an inner surface thereof and having an inclined surface. The guide portion includes an elastic strip formed in a lower end periphery thereof and configured to press the conductor bar held in the receiving space against the second side wall. The retainer strip projects into the upper opening, thereby defining an upper opening portion in the upper opening.

### CROSS-REFERENCE TO RELATED APPLICATIONS

This application claims priority to Japanese Patent Application serial number 2024-003104, filed Jan. 12, 2024 and Japanese Patent Application serial number 2024-213148, filed Dec. 6, 2024, the contents of which are incorporated herein by reference.

### BACKGROUND

The disclosure relates generally to a clip. More specifically, the disclosure relates to a clip used for holding and supporting a conductor bar or bus bar.

A known clip is taught by, for example, Japanese Laid-Open Patent Publication No. 2003-339111 (JP2003-339111A). The clip taught by Japanese Laid-Open Patent Publication No. 2003-339111 is used for attaching a flat cable to an object member (e.g. a vehicle body panel). In particular, the clip is configured to hold and support the flat cable. Further, the clip is configured to be connected to the object member. The clip includes first and second side walls positioned opposite to each other and a bottom wall. The first and second side walls and the bottom wall are integrally connected so as to have a substantially U-shape as a whole. Further, the clip has an engagement projection formed in an upper end of the second side wall and projecting toward the first side wall. The clip thus constructed has a cable receiving space formed therein, and an upper opening formed between an upper end of the first side wall and the engagement projection formed in the second side wall and being continuous with the cable receiving space. Further, the clip includes an engagement leg formed in the first side wall and configured to engage an engagement hole formed in the object member.

In order to attach the flat cable to the object member, first, the engagement leg formed in the clip is inserted into the engagement hole formed in the object member. Upon insertion of the engagement leg into the engagement hole, the clip is connected to the object member. Thereafter, the flat cable is inserted into the cable receiving space of the clip through the upper opening from above. As a result, the flat cable may be received within the cable receiving space, so as to be held by the clip. In this condition, the engagement projection formed in the second side wall of the clip contacts or engages an upper surface of the flat cable, thereby preventing the flat cable from unexpectedly dropping off the cable insertion space. Thus, the flat cable may be attached to the object member via the clip.

Therefore, the clip can be easily connected to the object member by simply inserting the engagement leg into the engagement hole of the object member. Further, the flat cable can be easily and quickly held by the clip connected to the object member. As a result, the flat cable can be easily and quickly attached to the object member via the clip. However, according to the clip, the engagement projection formed in the second side wall may slightly and gently contact the upper surface of the flat cable. Therefore, the flat cable cannot be sufficiently prevented from dropping off the cable receiving space of the clip. That is, the flat cable cannot be reliably and stably attached to the object member.

Therefore, there is a need in the art for an improved clip.

### SUMMARY

In one aspect of the present disclosure, a clip configured to hold an elongated conductor bar may include a structurally rigidified base, a first side wall and a second side wall vertically extending upward from the base and having an upper opening that is configured to allow the conductor bar to pass therethrough, a receiving space defined by the base, the first side wall and the second side wall and configured to hold the conductor bar therein, and a retainer strip formed in an upper end of the second side wall and configured to cover an upper surface of the conductor bar held in the receiving space. The first side wall is configured to have rigidity. The second side wall is configured to elastically deform in a direction away from the first side wall. The first side wall includes a guide portion formed in an inner surface thereof and having an inclined surface that is configured to obliquely guide the conductor bar passing through the upper opening to the receiving space. The guide portion includes an elastic strip formed in a lower end periphery thereof and configured to press the conductor bar held in the receiving space against the second side wall. The retainer strip projects into the upper opening, thereby defining an upper opening portion in the upper opening.

According to this aspect, when the conductor bar is received in the receiving space, an upper surface of the conductor bar is pressed and covered by the retainer strip of the second side wall. Further, in this condition, the conductor bar may be pressed against the second side wall by the elastic strip formed in the first side wall. Therefore, the conductor bar may be reliably held in the receiving space of the clip. Thus, the conductor bar may be effectively prevented from dropping off the clip.

Additional objects, features and advantages of the present disclosure will be readily understood after reading the following detailed description together with the accompanying drawings and the claims.

### BRIEF DESCRIPTION OF THE DRAWINGS

FIG. 1 is a perspective view of a clip (clips) according to a first representative embodiment, a bus bar, an attachment bracket (attachment brackets) formed in a vehicle body and a battery attached to the vehicle body, which shows a condition in which they are separated from each other;

FIG. 2 is an enlarged perspective view of the clip;

FIG. 3 is an elevational view of FIG. 2;

FIG. 4 is a right side view of FIG. 2;

FIG. 5 is a plan view of FIG. 2;

FIG. 6 is a bottom view of FIG. 2;

FIG. 7 is an explanatory view of a first insertion step of the bus bar into a bus bar receiving space of the clip attached to the attachment bracket, which shows a condition before the bus bar is inserted into the bus bar receiving space;

FIG. 8 is an explanatory view of a second insertion step of the bus bar into the bus bar receiving space of the clip attached to the attachment bracket, which shows a condition immediately before the bus bar is inserted into the bus bar receiving space;

FIG. 9 is an explanatory view of a third insertion step of the bus bar into the bus bar receiving space of the clip attached to the attachment bracket, which shows a condition in which the bus bar is slightly inserted into the bus bar receiving space through an upper opening of the clip;

FIG. 10 is an explanatory view of a fourth insertion step of the bus bar into the bus bar receiving space of the clip attached to the attachment bracket, which shows a condition in which the bus bar is obliquely progressively inserted into the bus bar receiving space;

FIG. 11 is an explanatory view of a fifth insertion step of the bus bar into the bus bar receiving space of the clip attached to the attachment bracket, which shows a condition in which the bus bar is vertically progressively inserted into the bus bar receiving space while outwardly flexing a second side wall of the clip;

FIG. 12 is an explanatory view of a final insertion step of the bus bar into the bus bar receiving space of the clip attached to the attachment bracket, which shows a condition in which the bus bar is completely inserted into and received in the bus bar receiving space;

FIG. 13 is a perspective view of the clip, the bus bar, and the attachment bracket with the battery, which shows a condition in which the bus bar is attached to the attachment bracket via the clip;

FIG. 14 is an explanatory plan view of a plurality of clips according to the first representative embodiment and the battery attached to the vehicle body, in which the clips are arranged in order to support an L-shaped bus bar;

FIG. 15 is an explanatory plan view of a first insertion step of the bus bar into the bus bar receiving space of each of the clips, which shows a condition in which the bus bar is positioned on the upper opening of each of the clips;

FIG. 16 is an explanatory side view of a second insertion step of the bus bar into the bus bar receiving space of each of the clips, which shows a condition in which the bus bar is progressively inserted into the bus bar receiving space;

FIG. 17 is an explanatory plan view of a final insertion step of the bus bar into the bus bar receiving spaces of the clips, which shows a condition in which the bus bar is completely inserted into and received in the bus bar receiving space;

FIG. 18 is an explanatory side view of a modified form of the second insertion step of the bus bar into the bus bar receiving space of each of the clips, which shows a condition in which the bus bar is progressively inserted into the bus bar receiving space;

FIG. 19 is an enlarged perspective view of a clip according to a second representative embodiment;

FIG. 20 is an elevational view of FIG. 19;

FIG. 21 is a right side view of FIG. 19;

FIG. 22 is a plan view of FIG. 19;

FIG. 23 is a bottom view of FIG. 19;

FIG. 24 is an enlarged elevational view of a clip according to a third representative embodiment;

FIG. 25 is an enlarged perspective view of a clip according to a fourth representative embodiment;

FIG. 26 is an enlarged perspective view of the clip, which is viewed from below;

FIG. 27 is an elevational view of FIG. 25;

FIG. 28 is an explanatory view of a first insertion step of a bus bar into a bus bar receiving space of the clip attached to an attachment bracket, which shows a condition before the bus bar is inserted into the bus bar receiving space;

FIG. 29 is an explanatory view of a second insertion step of the bus bar into the bus bar receiving space of the clip attached to the attachment bracket, which shows a condition immediately before the bus bar is inserted into the bus bar receiving space;

FIG. 30 is an explanatory view of a third insertion step of the bus bar into the bus bar receiving space of the clip attached to the attachment bracket, which shows a condition in which the bus bar is slightly inserted into the bus bar receiving space through an upper opening of the clip;

FIG. 31 is an explanatory view of a fourth insertion step of the bus bar into the bus bar receiving space of the clip attached to the attachment bracket, which shows a condition in which the bus bar is obliquely progressively inserted into the bus bar receiving space;

FIG. 32 is an explanatory view of a fifth insertion step of the bus bar into the bus bar receiving space of the clip attached to the attachment bracket, which shows a condition in which the bus bar is vertically progressively inserted into the bus bar receiving space while outwardly flexing a second side wall of the clip;

FIG. 33 is an explanatory view of a final insertion step of the bus bar into the bus bar receiving space of the clip attached to the attachment bracket, which shows a condition in which the bus bar is completely inserted into and received in the bus bar receiving space;

FIG. 34 is an enlarged perspective view of a clip according to a fifth representative embodiment;

FIG. 35 is an enlarged perspective view of the clip, which is viewed from below; and

FIG. 36 is an elevational view of FIG. 34.

### DETAILED DESCRIPTION OF THE DRAWINGS

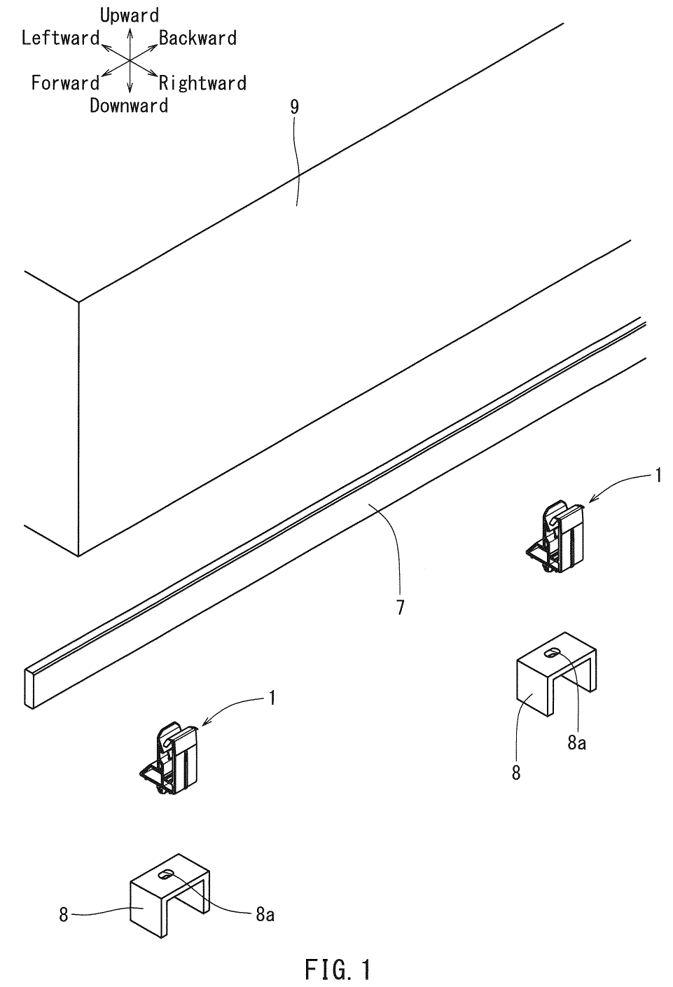

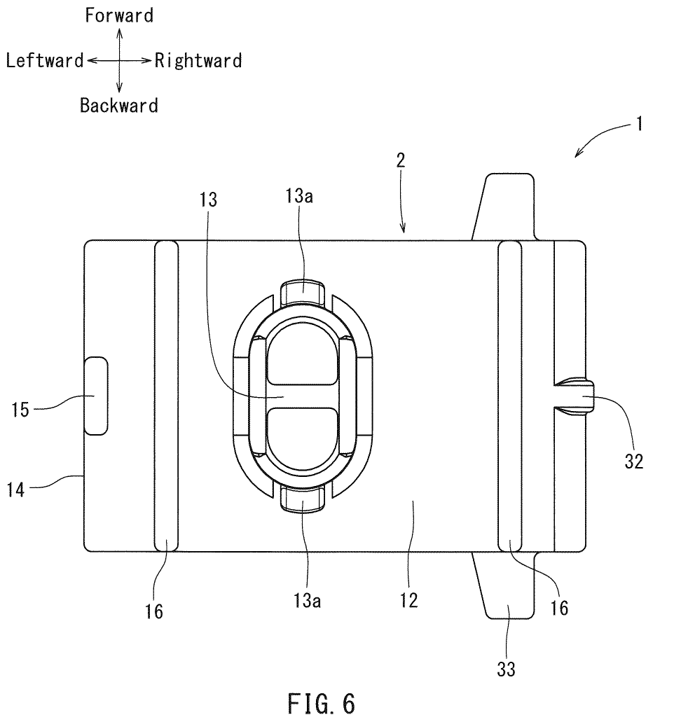

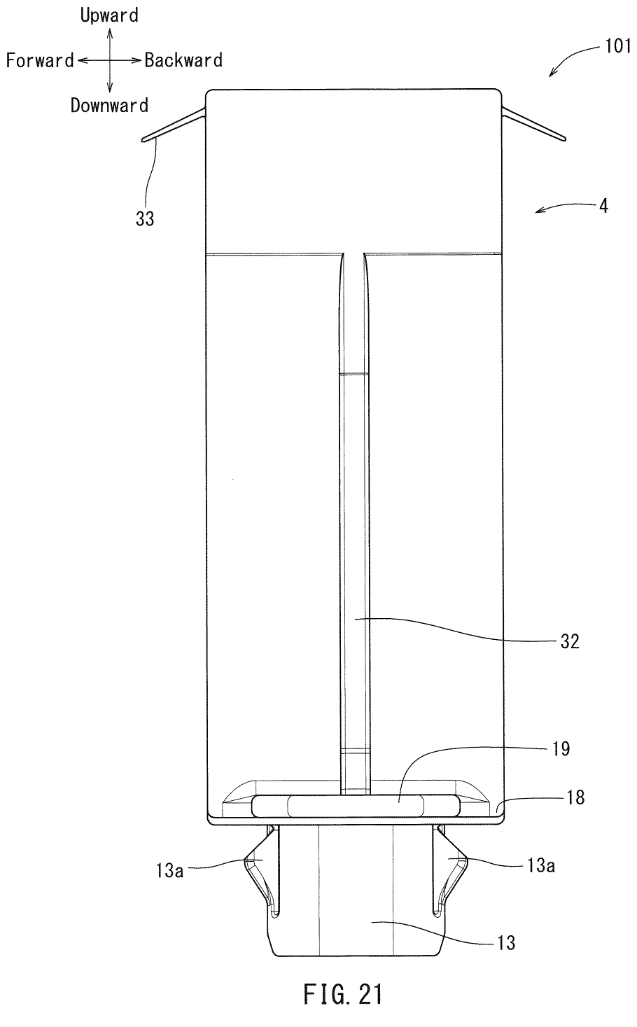

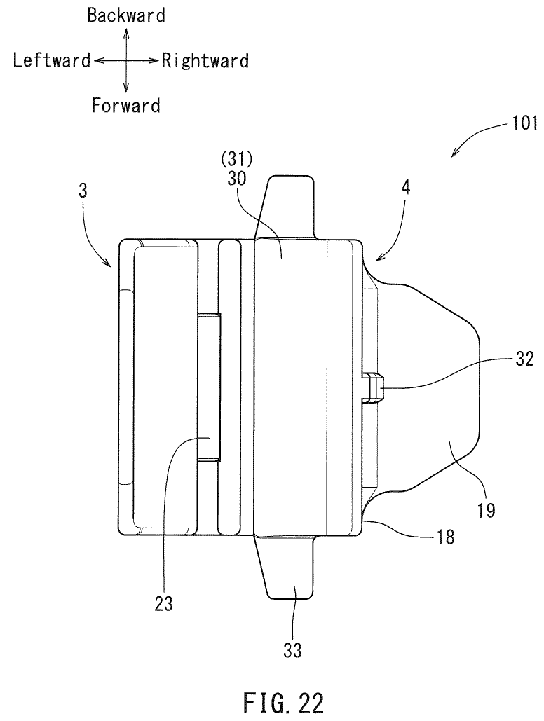

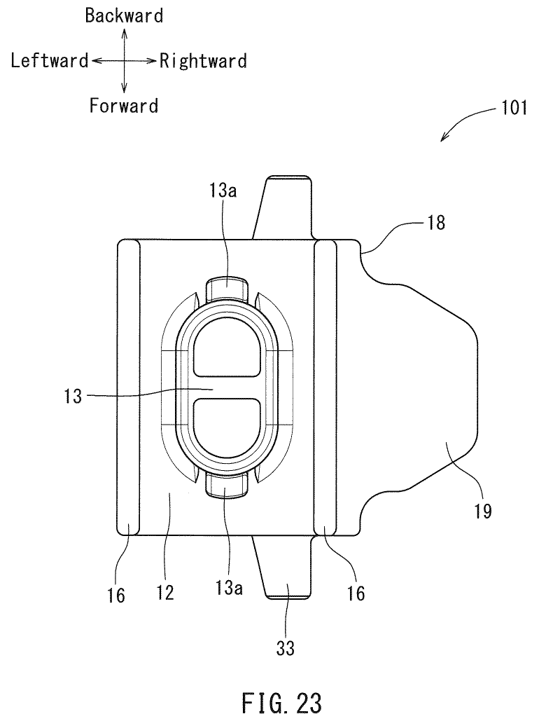

Detailed representative embodiments of the present disclosure are shown in FIGS. 1 to 24.

In the following, a first embodiment will be described in detail with reference to FIGS. 1 to 18. Further, forward, backward, rightward, leftward, upward and downward directions described with reference to the figures may be defined simply for descriptive purposes.

As shown in FIG. 1, a clip 1 according to the first embodiment may be used for attaching an elongated conductor bar or bus bar 7 to a vehicle body (not shown). The bus bar 7 generally has a rectangular shape in cross section. In particular, the clip 1 is configured to hold and support the bus bar 7. Further, the clip 1 is configured to be connected to an attachment bracket 8 formed in the vehicle body and having an elliptical engagement hole 8a. Therefore, the bus bar 7 can be attached to the vehicle body via the clip 1 connected to the attachment bracket 8. Generally, the bus bar 7 is preferably positioned adjacent to a battery 9 (e.g., a battery stack) separately attached to the vehicle body. Therefore, the attachment bracket 8 may be formed in the vehicle body so as to be positioned adjacent to the battery 9. Further, a plurality of clips, a plurality of attachment brackets may generally be used in order to attach the bus bar 7 to the vehicle body. Therefore, in the following, the clip 1 and the attachment bracket 8 may be used in plural (clips 1 and attachment brackets 8) for explanatory convenience.

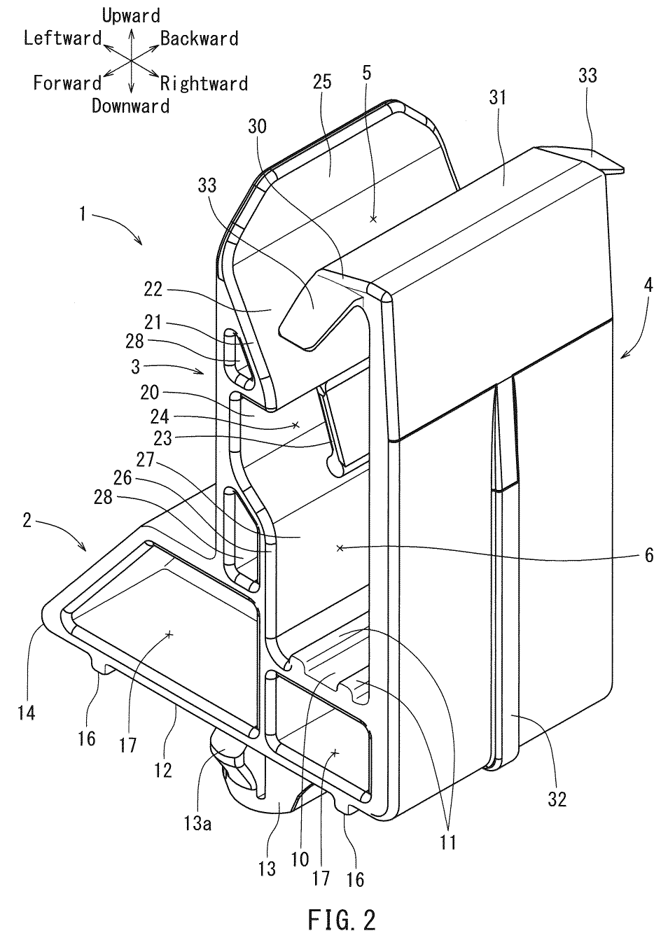

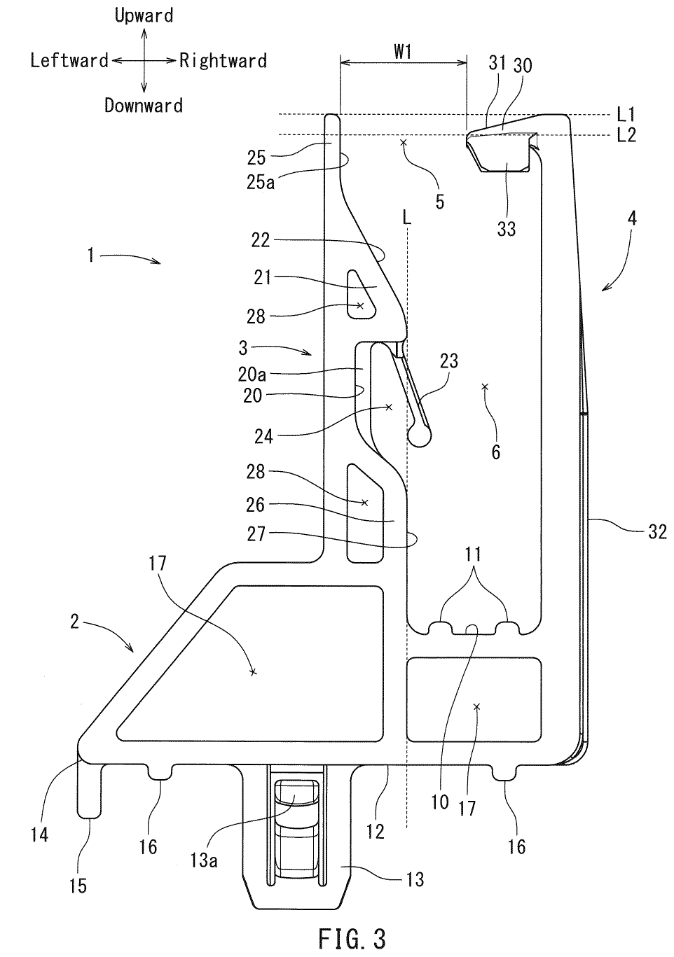

As shown in FIGS. 2 and 3, the clip 1 includes a structurally rigidified base 2 having a trapezoidal shape in cross section, a first side wall 3 and a second side wall 4 vertically extending upward from the base 2. The first side wall 3 and the second side wall 4 are positioned laterally opposite to each other at a certain interval. The base 2, the first side wall 3 and the second side wall 4 are integrally connected so as to have a substantially U-shape as a whole. As shown in FIG. 3, the clip 1 includes an upper opening (not labeled) formed between the first side wall 3 and the second side wall 4 and configured to allow the bus bar 7 to pass therethrough. Further, the clip 1 has a receiving space 6 (which will be hereinafter simply referred to as the receiving space 6) formed therein so as to be continuous with the upper opening. In particular, the receiving space 6 is defined by the base 2, the first side wall 3 and the second side wall 4. The receiving space 6 is configured to receive the bus bar 7 therein. Further, the clip 1 is preferably integrally formed as a unit by injection molding of synthetic resins, e.g., polypropylene (PP).

As shown in FIGS. 2 and 3, the clip 1 includes an anchor or engagement leg 13 formed in a lower surface 12 of the base 2 and having a pair of engagement strips 13a. The pair of engagement strips 13a are formed in the engagement leg 13 so as to be oppositely positioned in a front-back direction. The engagement strips 13a are configured to engage the engagement hole 8a of the attachment bracket 8 such that the base 2 (the clip 1) can be connected to the attachment bracket 8 via the engagement leg 13. Further, the clip 1 includes a vertical projection 15 formed in the lower surface 12 of the base 2 for proper positioning of the clip 1 in a lateral direction. Further, the engagement leg 13 is positioned so as not to be vertically aligned with the receiving space 6 formed in the clip 1. In other words, the engagement leg 13 is positioned such that its axis line is laterally offset from an axis line the receiving space 6.

As shown in FIGS. 2 and 3, the base 2 includes a pair of upper ribs 11 formed in an upper surface 10 thereof and projecting into the receiving space 6. The upper ribs 11 are preferably arranged so as to extend in the front-back direction. Further, the base 2 includes a pair of lower ribs 16 formed in the lower surface 12 thereof and extending in the front-back direction. The lower ribs 16 are positioned on either side of the engagement leg 13 so as to function as a stabilizer of the base 2 relative to the attachment bracket 8.

As shown in FIGS. 2 and 3, the base 2 includes a pair of hollow portions 17 extending in a front-back direction and each having a trapezoidal shape or a rectangular shape in cross section. Further, the hollow portions 17 have ribs (not labeled) formed in their inner surfaces and extending along their circumferential peripheries. Such ribs may contribute to increase of rigidity of the base 2.

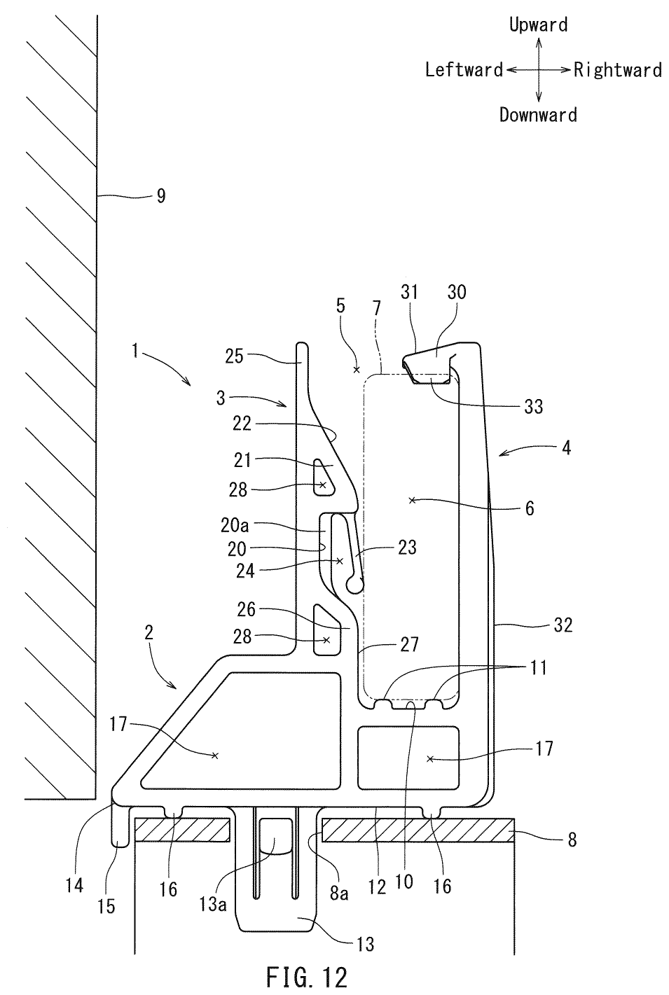

As shown in FIGS. 2 and 3, the first side wall 3 is configured to have predetermined rigidity. The first side wall 3 includes a guide portion 21 formed in an inner surface 20 thereof and having an inclined surface 22. The inclined surface 22 is configured to obliquely guide the bus bar 7 passing through the upper opening to the receiving space 6. Further, the guide portion 21 includes an elastic strip 23 formed in a lower end periphery thereof and configured to press the bus bar 7 introduced into the receiving space 6 against the second side wall 4. Further, the elastic strip 23 is configured to press a portion of a lower half of the bus bar 7 (FIG. 12).

As shown in FIGS. 2 and 3, the first side wall 3 includes a bulged portion 26 formed in its proximal end and bulged toward the second side wall 4. Further, as shown by a line L in FIG. 3, the bulged portion 26 is configured such that a bulging surface 27 thereof is vertically aligned with a lower end of the inclined surface 22 of the guide portion 21. That is, the bulged portion 26 is configured such that the bulging surface 27 thereof and the lower end of the inclined surface 22 of the guide portion 21 is positioned on a vertical straight line. Further, the first side wall 3 includes a clearance 24 formed therein so as to be positioned between the guide portion 21 and the bulged portion 26. The clearance 24 is configured to allow the elastic strip 23 to flex toward the first side wall 3.

As shown in FIG. 3, the first side wall 3 includes a vertically elongated rib 20a formed in the inner surface 20 and extending from the guide portion 21 to the bulged portion 26. The rib 20a is formed in a central portion of the inner surface 20 in the front-back direction and has a desired thickness. Thus, the first side wall 3 may be effectively rigidified. Further, the first side wall 3 includes a vertical guide strip 25 (which will be hereinafter simply referred to as the guide strip 25) projecting upward from the guide portion 21. The guide strip 25 is configured such that its upper end surface (not labeled) may define a distal or upper end (not labeled) of the first side wall 3. As shown in FIGS. 2 and 3, the guide portion 21 includes a hollow portion 28 having a triangular shape in cross section and extending in the front-back direction. Further, the hollow portion 28 has ribs (not labeled) formed in an inner surface thereof and extending along circumferential peripheries of the hollow portion 28. Similarly, the bulged portion 26 includes the hollow portion 28. However, the hollow portion 28 formed in the bulged portion 26 has a trapezoidal shape in cross section.

As shown in FIGS. 2 and 3, the second side wall 4 is configured to flex or elastically deform in a direction away from the first side wall 3. The second side wall 4 is configured to be gradually reduced in thickness from its proximal end toward its distal end. Further, the second side wall 4 includes a bus bar retainer strip 30 formed in its distal or upper end (not labeled) and projecting into the upper opening in a direction toward the first side wall 3. The bus bar retainer strip 30 is configured to engage and cover an upper surface of the bus bar 7 received in the receiving space 6 (FIG. 12). Further, the bus bar retainer strip 30 includes an upper surface 31. The bus bar retainer strip 30 (the upper surface 31) is inclined downward from its proximal end portion toward the first side wall 3 (the upper opening) such that its distal end portion is positioned below the upper end of the first side wall 3 (i.e., such that its distal end portion is positioned below the upper end surface of the guide strip 25).

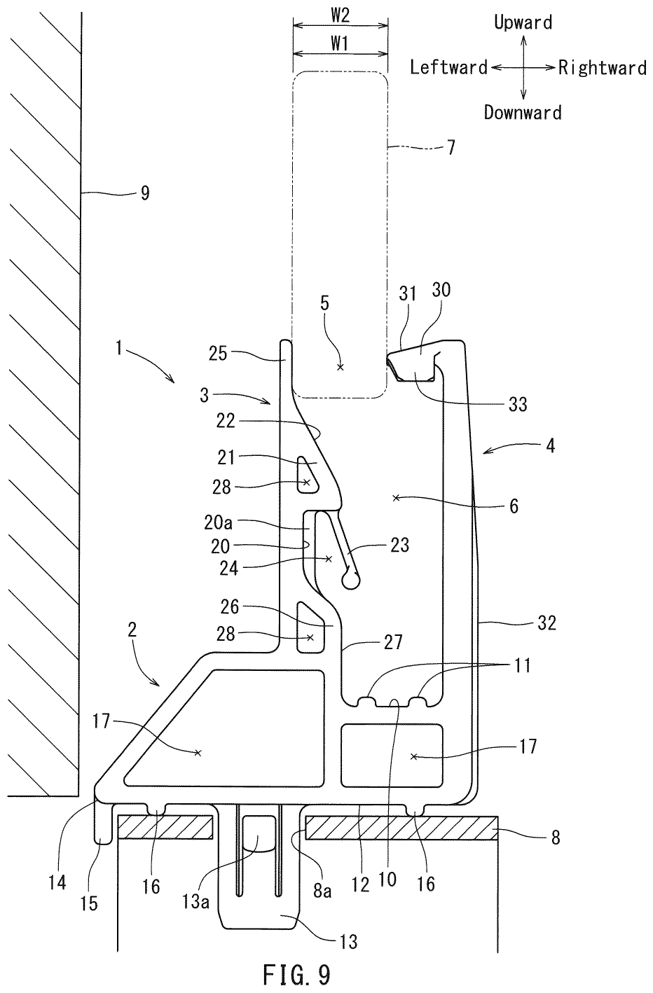

As previously described, the upper opening is formed between the first side wall 3 and the second side wall 4. In particular, the upper opening formed between the upper end of the first side wall 3 and the upper end of the second side wall 4. However, the second side wall 4 includes the bus bar retainer strip 30 formed in the upper end thereof and projecting into the upper opening. Therefore, the upper opening is narrowed or defined by the bus bar retainer strip 30. As a result, a narrowed or defined upper opening (which will be hereinafter referred to as an upper opening portion 5) is formed in the upper opening as a portion of the upper opening (FIG. 3). Further, the upper opening portion 5 has a width W1 substantially equal to a thickness W2 of the bus bar 7 (FIG. 9).

As shown by a line L1 in FIG. 3, the second side wall 4 is configured such that the upper end thereof is substantially the same height as the upper end of the first side wall 3. In other words, the second side wall 4 is configured such that the proximal end portion of the bus bar retainer strip 30 (the upper surface 31) is substantially the same height as the upper end surface of the guide portion 25. As described above, the bus bar retainer strip 30 is inclined downward from its proximal end portion toward the first side wall 3. Therefore, as shown by a line L2 in FIG. 3, the bus bar retainer strip 30 is obliquely directed from the upper end of the second side wall 4 toward the first side wall 3. In particular, the bus bar retainer strip 30 is obliquely directed from the upper end of the second side wall 4 toward an inner surface 25a of the guide strip 25 of the first side wall 3. Further, the bus bar retainer strip 30 is configured to cover a substantial portion of the upper surface of the bus bar 7 when the bus bar 7 is received in the receiving space 6 (FIG. 12). In particular, the bus bar retainer strip 30 is configured to cover more than half, preferably 70%, of the upper surface of the bus bar 7.

As shown in FIGS. 2 to 4, the bus bar retainer strip 30 includes elastic or flexible strips 33 respectively formed in a front and back ends thereof. The flexible strips 33 may function to reliably hold the bus bar 7 within the receiving space 6 even when the bus bar 7 is moved in the receiving space 6 by vibration.

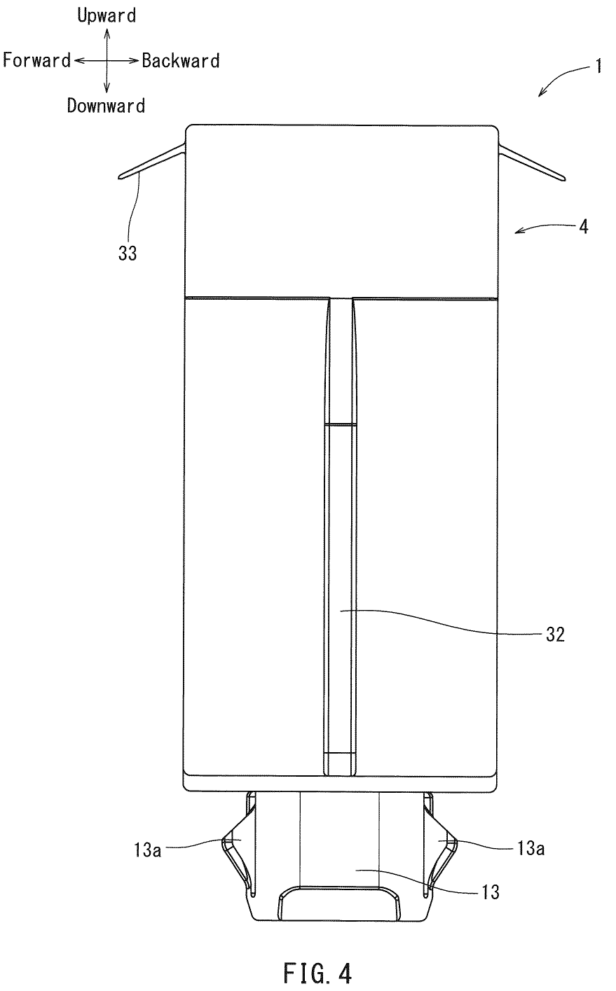

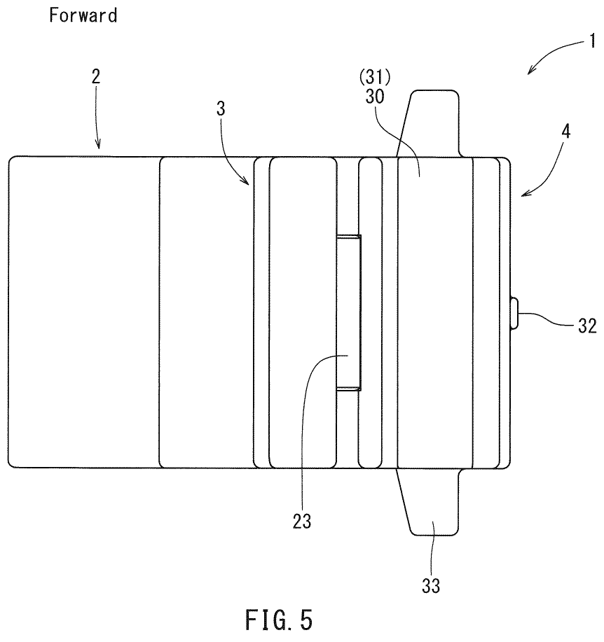

As shown in FIGS. 2 and 3, the second side wall 4 includes a vertical rib 32 formed in its outer surface and extending from its proximal end toward its distal end. The vertical rib 32 is formed in a central portion of the second side wall 4 in the front-back direction (FIGS. 4 and 5). The rib 32 is configured to be gradually reduced in height (thickness) toward the distal end of the second side wall 4. Further, the second side wall 4 is configured such that a distance between the upper ribs 11 of the base 2 and the bus bar retainer strip 30 is substantially equal to a height of the bus bar 7 (FIG. 12).

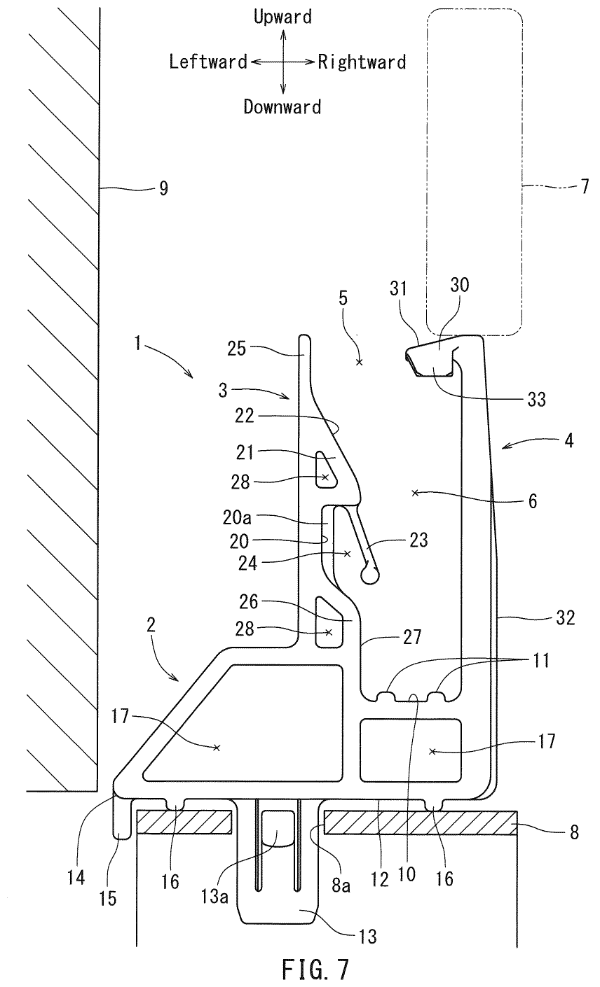

As shown in FIGS. 7 to 12, the attachment bracket 8 is positioned adjacent to the battery 9. Further, the engagement hole 8a of the attachment bracket 8 is offset to or displaced toward the battery 9 such that the projection 15 formed in the base 2 of the clip 1 does not interfere with the attachment bracket 8 provided that the clip 1 is properly positioned on the attachment bracket 8. Therefore, when the clip 1 is properly positioned on the attachment bracket 8, the engagement leg 13 of the clip 1 can be inserted into the engagement hole 8a of the attachment bracket 8. As a result, the clip 1 can be attached to the attachment bracket 8.

However, when the clip 1 is not properly positioned on the attachment bracket 8, i.e., when the clip 1 is positioned on the attachment bracket 8 in a condition in which the clip 1 is laterally inversely oriented (i.e., oriented opposite to a normal orientation shown in FIGS. 7 to 12), the projection 15 formed in the base 2 may interfere with the attachment bracket 8 due to offset of the engagement hole 8a. Therefore, the engagement leg 13 cannot be inserted into the engagement hole 8a of the attachment bracket 8. As a result, in the condition in which the clip 1 is laterally inversely oriented, the clip 1 cannot be attached to the attachment bracket 8. Thus, the projection 15 may contribute to ease of proper positioning of the clip 1.

Next, a method of attaching the bus bar 7 to the (two) attachment brackets 8 using the (two) clips 1 will now be described in detail with reference to FIGS. 1, and 7 to 13. Further, as shown in FIG. 1, in the method, a linear bus bar is shown as an example of the bus bar 7.

In order to attach the bus bar 7 to the attachment brackets 8 (one of which is shown in FIGS. 7 to 12), first, the clips 1 (one of which is shown in FIGS. 7 to 12) are connected to the attachment brackets 8 by simply inserting the engagement leg 13 of each of the clips 1 into the engagement hole 8a of each of the attachment brackets 8. Further, each of the clips 1 may be properly positioned such that the projection 15 formed in the base 2 does not interfere with each of the attachment bracket 8.

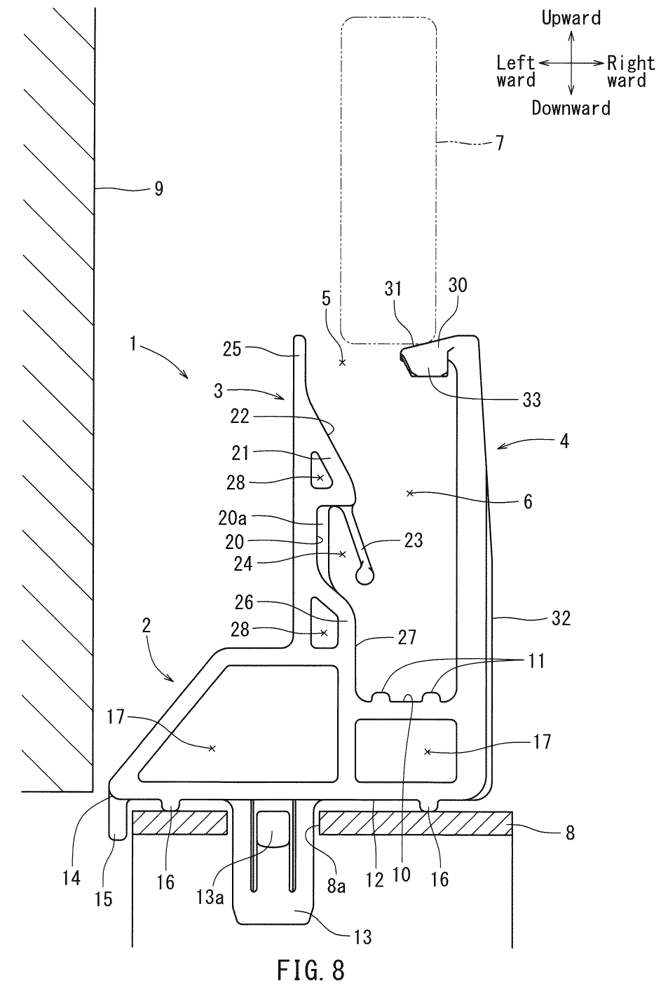

Thereafter, as shown in FIG. 7, the bus bar 7 is positioned on the upper surface 31 of the bus bar retainer strip 30 of the second side wall 4 of each of the clips 1. Further, as shown in FIG. 8, the bus bar 7 is pressed downward so as to be slid along the upper surface 31 toward the upper opening portion 5. As a result, as shown in FIG. 9, the bus bar 7 may be partially introduced into the receiving space 6 through the upper opening portion 5 while contacting the guide strip 25 of the first side wall 3 of each of the clips 1, because the upper opening portion 5 has the width W1 (FIG. 3) substantially equal to the thickness W2 of the bus bar 7. Further, as shown in FIG. 9, the bus bar 7 partially introduced into the receiving space 6 through the upper opening portion 5 may be temporarily supported by the inclined surface 22 of the guide portion 21 of the first side wall 3 while contacting the guide strip 25 and the bus bar retainer strip 30.

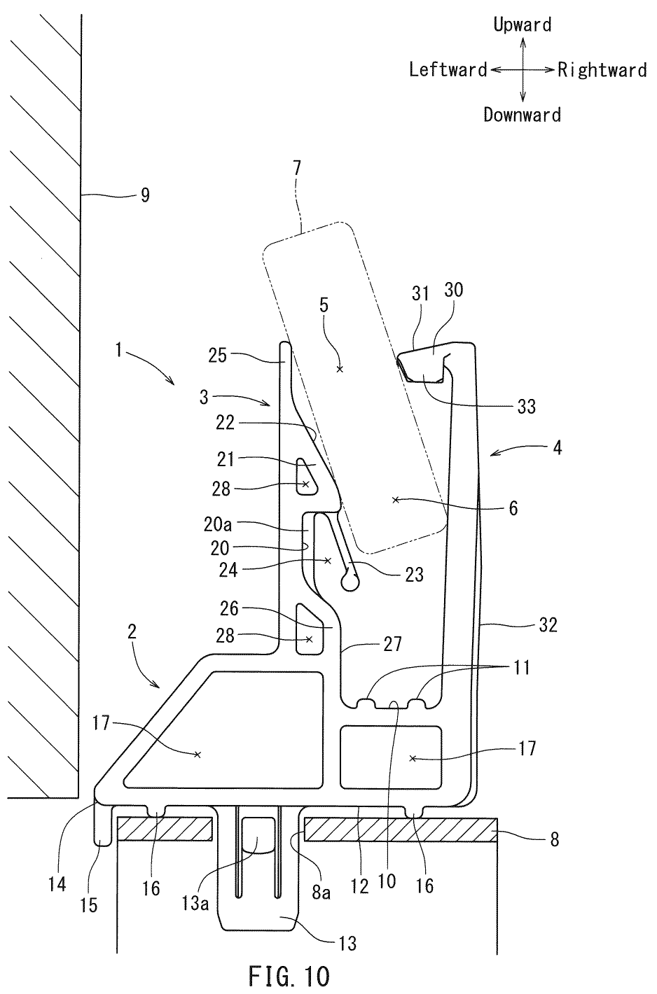

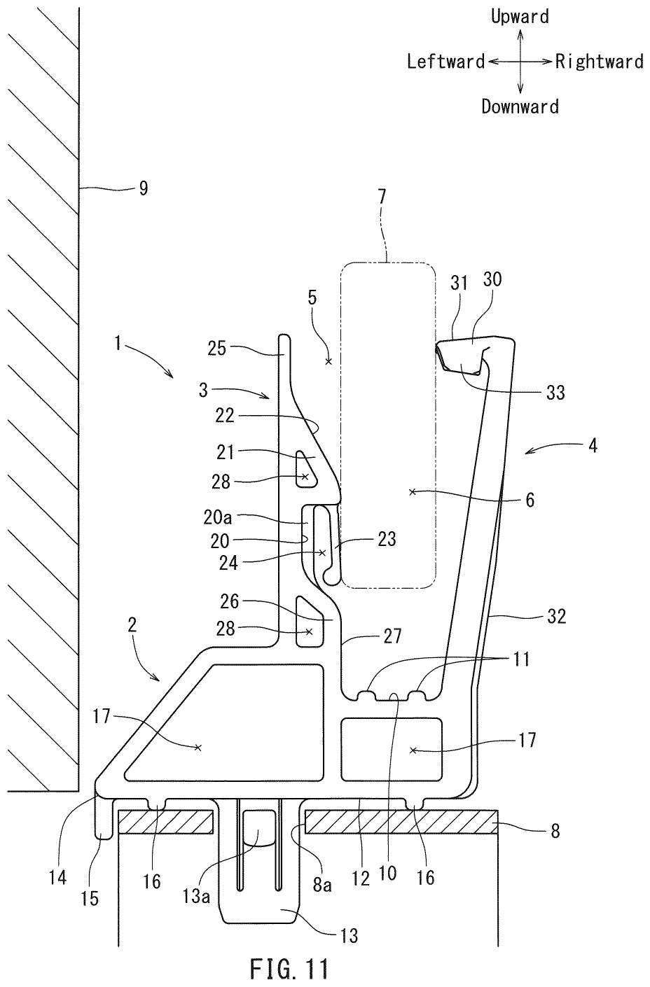

Thereafter, as shown in FIG. 10, the bus bar 7 temporarily supported by the guide portion 21 is further pressed downward. As a result, the bus bar 7 may be obliquely introduced into the receiving space 6 along the inclined surface 22 of the guide portion 21 of the first side wall 3. As shown in FIG. 11, when the bus bar 7 is further pressed downward, the bus bar 7 may be changed in direction and then be vertically introduced into the receiving space 6 while flexing the elastic strip 23 of the guide portion 21 of the first side wall 3 inward within the clearance 24 and simultaneously flexing the second side wall 4 outward.

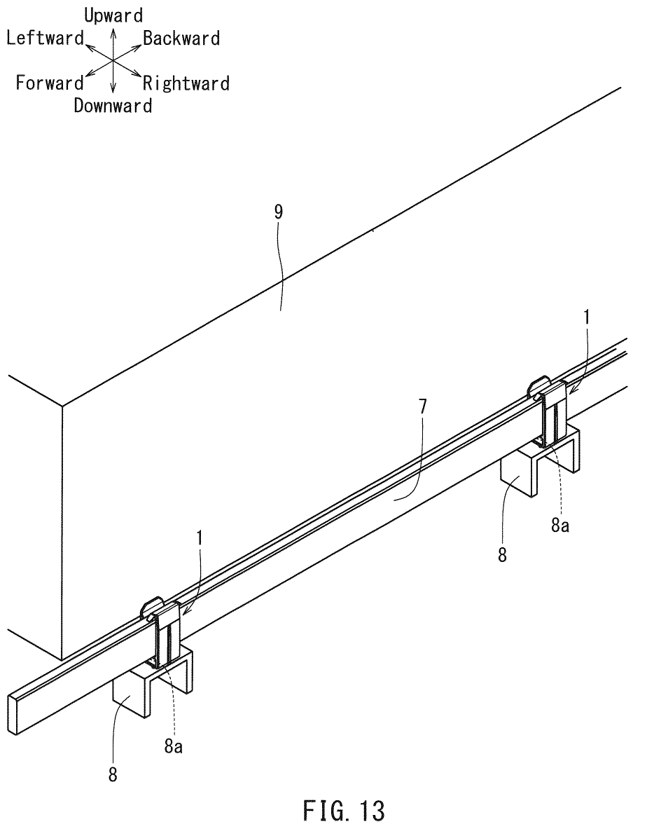

As shown in FIG. 12, when the bus bar 7 is further pressed downward until its lower surface contacts the upper ribs 11 of the base 2, the second side wall 4 may be elastically restored inward. As a result, the bus bar 7 may be completely received in the receiving space 6 in a condition in which its upper surface is pressed and covered by the bus bar retainer strip 30 of the second side wall 4. Further, in this condition, the bus bar 7 may be pressed against the second side wall 4 by the elastic strip 23 formed in the first side wall 3. Therefore, the bus bar 7 may be stably received in the receiving space 6 of each of the clips 1. That is, the bus bar 7 may be effectively prevented from dropping off each of the clips 1. Thus, as shown in FIG. 13, the bus bar 7 may be attached to the attachment brackets 8 via the clips 1.

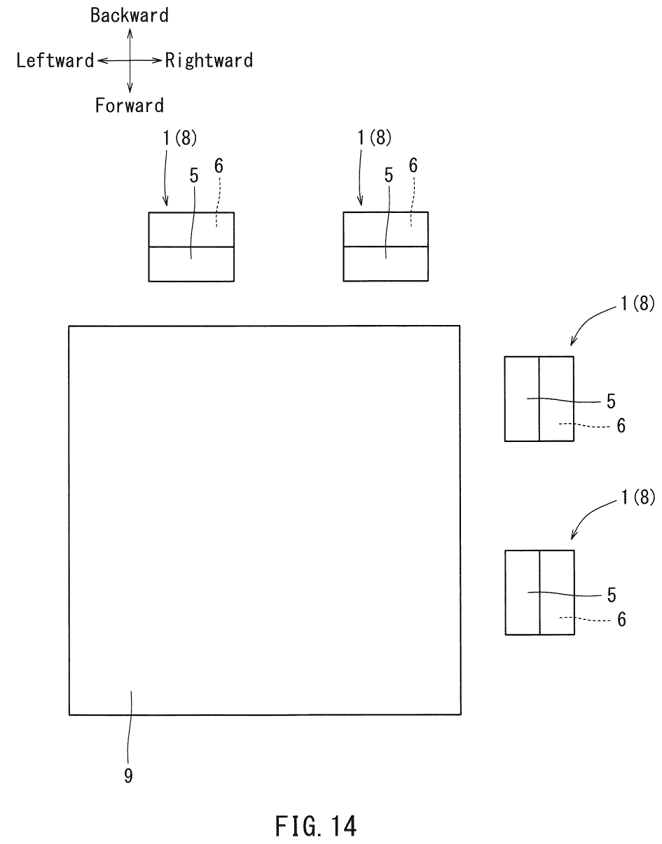

Next, a method of attaching the bus bar 7 to the (four) attachment brackets 8 using the (four) clips 1 will now be described in detail with reference to FIGS. 14 to 18. Further, in the method, an L-shaped bus bar having mutually orthogonal first and second portions 7a, 7b is shown as an example of the bus bar 7.

In order to attach the bus bar 7 to the attachment brackets 8, first, the clips 1 are connected to the attachment brackets 8 by simply inserting the engagement leg 13 of each of the clips 1 into the engagement hole 8a of each of the attachment brackets 8. Further, as shown in FIG. 14, the attachment brackets 8 may be positioned along mutually orthogonal two sides of the battery 9 in pairs.

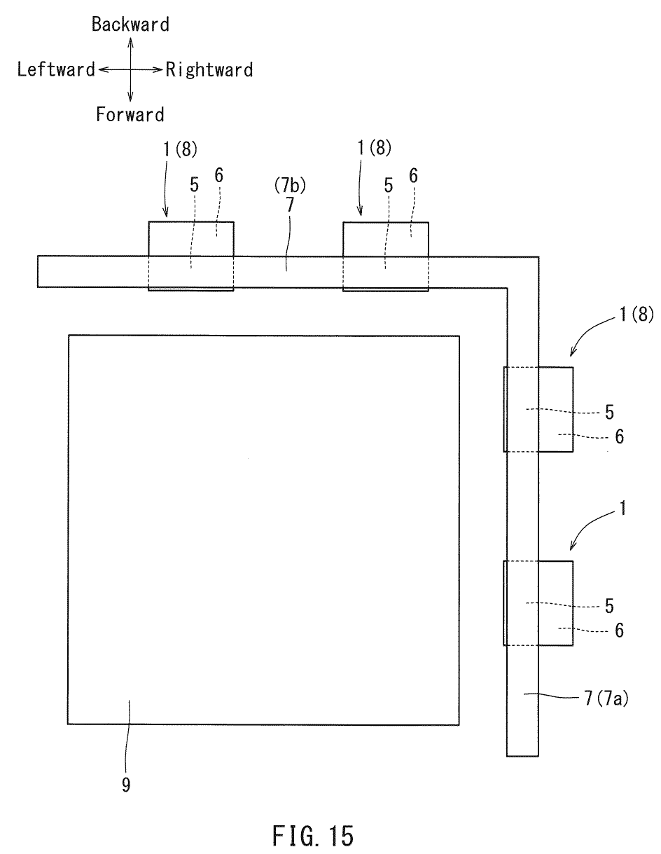

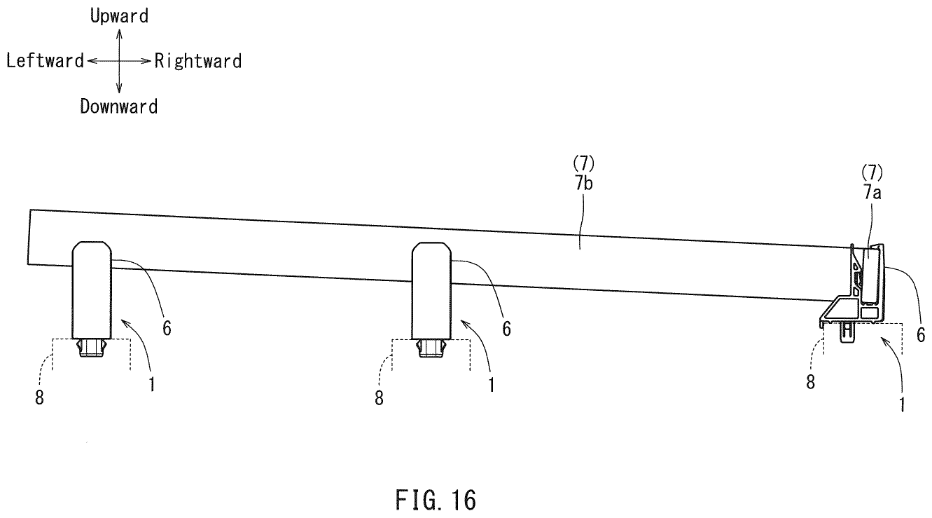

Thereafter, as shown in FIG. 15, the first portion 7a of the bus bar 7 is positioned on the upper opening portion 5 of each of the clips 1 corresponding thereto, which may be referred to as a first operation. Simultaneously, the second portion 7b of the bus bar 7 is positioned on the upper opening portion 5 of each of the clips 1 corresponding thereto, which may be referred to as a second operation. Thereafter, as shown in FIG. 16, the first portion 7a of the bus bar 7 is pressed into the receiving space 6 of each of the clips 1, which may be referred to as a third operation. Similarly, the second portion 7b of the bus bar 7 is pressed into the receiving space 6 of each of the clips 1, which may be referred to as a fourth operation.

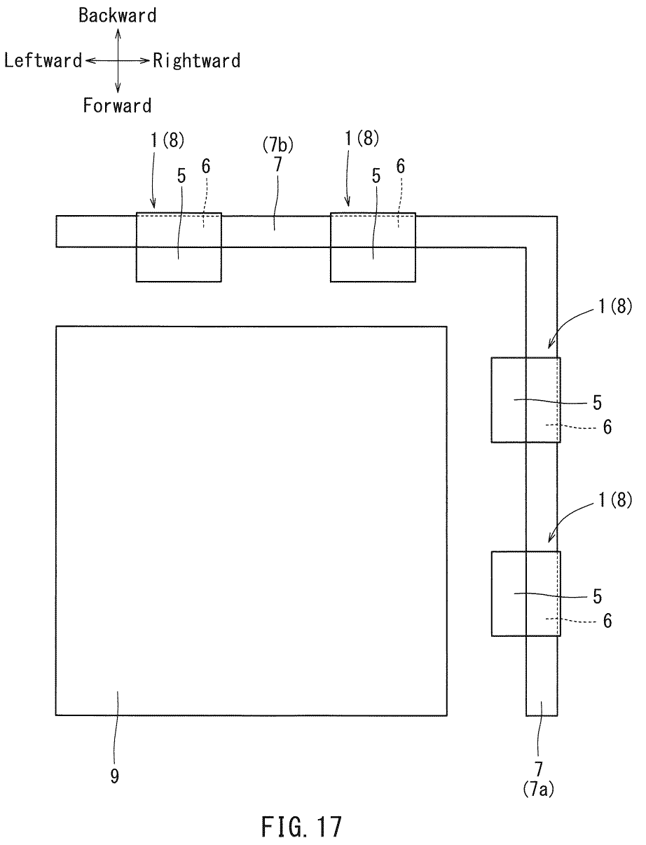

As a result, as shown in FIG. 17, the first portion 7a and the second portion 7b of the bus bar 7 may be introduced into and received in the receiving space 6 of each of the clips 1 in the same manner as in the case shown in FIGS. 9 to 12. Thus, the bus bar 7 may be attached to the attachment brackets 8 via the clips 1.

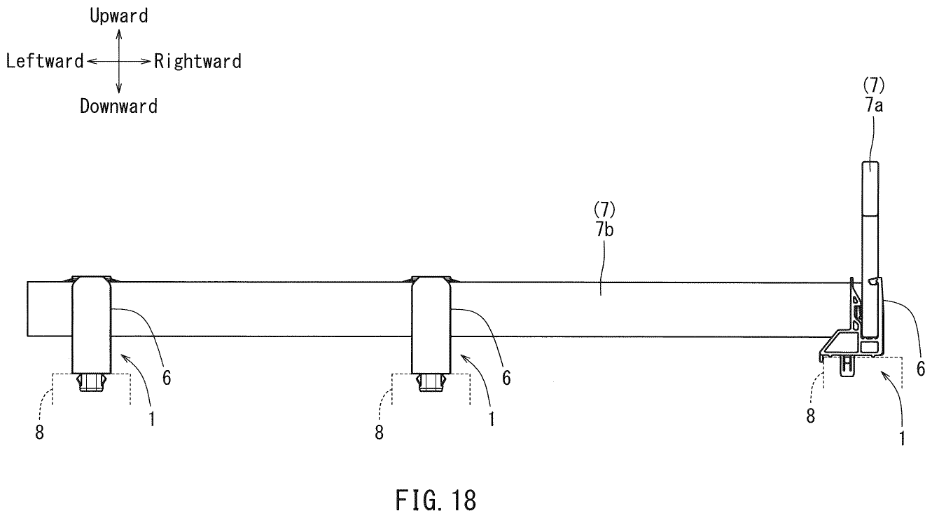

Further, as shown in FIG. 18, the third operation and the fourth operation can be interchanged as necessary. Naturally, the third operation and the fourth operation can be simultaneously performed.

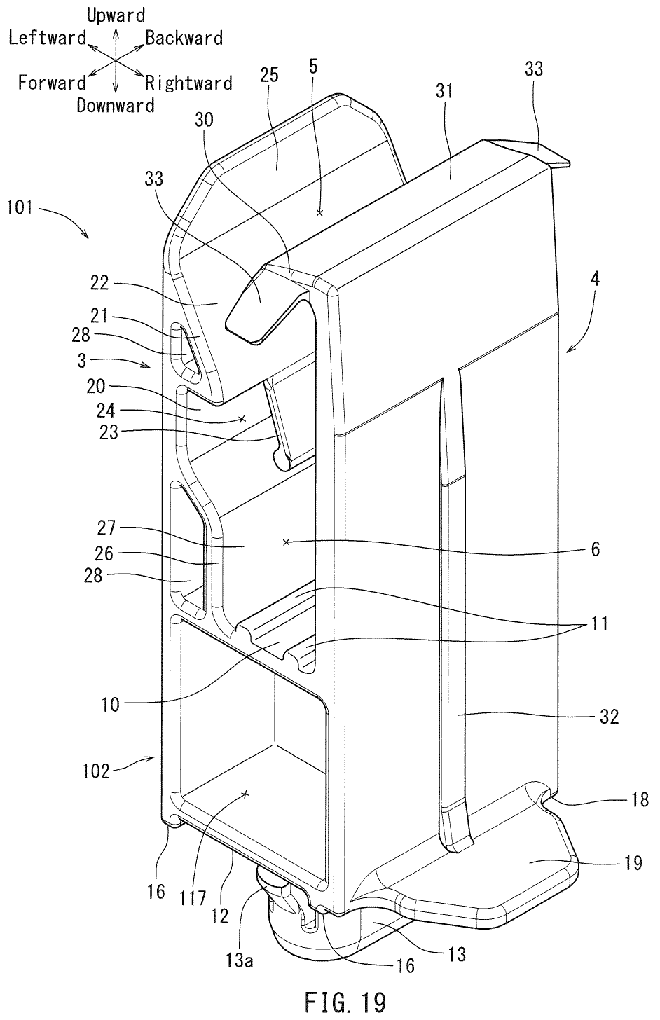

Next, a second embodiment will be described in detail with reference to FIGS. 19 to 23. Because the second embodiment relates to the first embodiment, only the constructions and elements that are different from the first embodiment will be explained in detail. Elements that are the same in the first and second embodiments will be identified by the same reference numerals and a detailed description of such elements may be omitted or simplified.

The second embodiment is directed to a clip 101. Similar to the clip 1 of the first embodiment, the clip 101 is used for attaching the bus bar 7 (not shown in FIGS. 19 to 23) to the vehicle body. However, the clip 101 according to the second embodiment is different from the clip 1 of the first embodiment in that the clip 101 includes a base 102 that is different from the base 2 of the clip 1 in shape. In particular, the base 102 has a rectangular shape in cross section whereas the base 2 has the trapezoidal shape in cross section. In addition, the base 102 includes a single hollow portion 117 having a rectangular shape in cross section. Thus, the clip 101 according to the second embodiment is substantially different from the clip 1 of the first embodiment in that the base 102 thereof is structurally different from the base 2 of the clip 1. Therefore, the clip 101 may be used in the same manner as the clip 1.

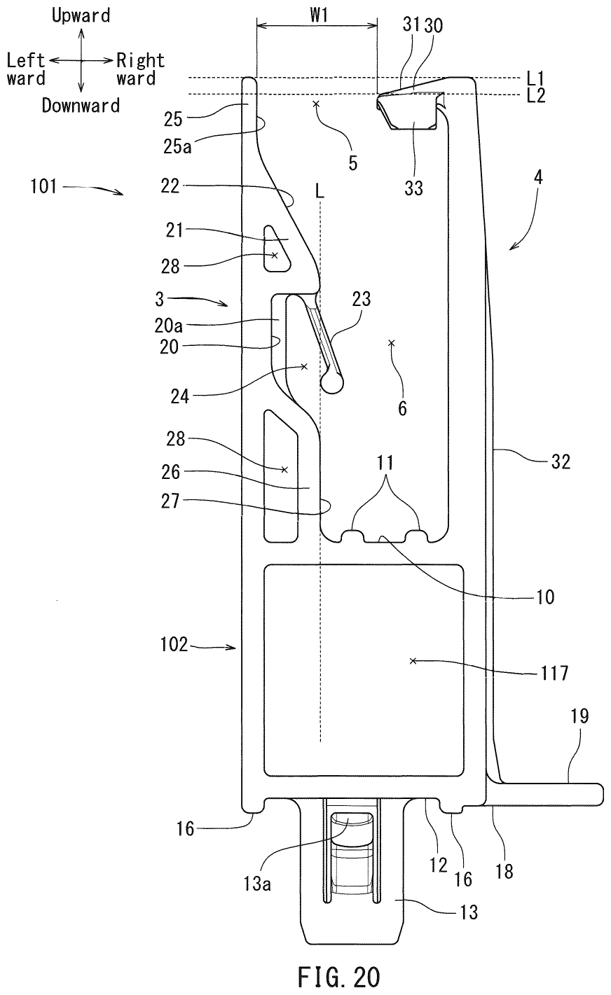

Further, as shown in FIG. 20, the clip 101 is different from clip 1 in that the engagement leg 13 is positioned so as to be substantially vertically aligned with the receiving space 6. That is, the engagement leg 13 is positioned so as not to be laterally offset from the receiving space 6. The clip 101 thus constructed may be simplified in structure.

Further, as shown in FIGS. 19 to 23, the clip 101 includes a subsidiary plate 19 instead of the projection 15 formed in the lower surface 12 of the base 2 of the clip 1. The subsidiary plate 19 is formed in a right lower end periphery 18 of the base 102 so as to horizontally extend rightward therefrom. Unlike the projection 15 of the clip 1, the subsidiary plate 19 is configured to interfere with the battery 9 (not shown in FIGS. 19 to 23) when the clip 101 is not properly positioned on the attachment bracket 8 (not shown in FIGS. 19 to 23). Therefore, the engagement leg 13 cannot be inserted into the engagement hole 8a of the attachment bracket 8. As a result, when the clip 1 is not properly positioned on the attachment bracket 8, the clip 101 cannot be attached to the attachment bracket 8. Thus, the subsidiary plate 19 may contribute to ease of proper positioning of the clip 101.

Further, the subsidiary plate 19 may function as a stabilizer of the clip 101. In particular, when the clip 101 is inclined on the engagement leg 13 in the lateral direction while the bus bar 7 (not shown in FIGS. 19 to 23) is introduced into the receiving space 6, the subsidiary plate 19 may effectively contact the attachment bracket 8, thereby preventing the clip 101 from being excessively inclined in the lateral direction.

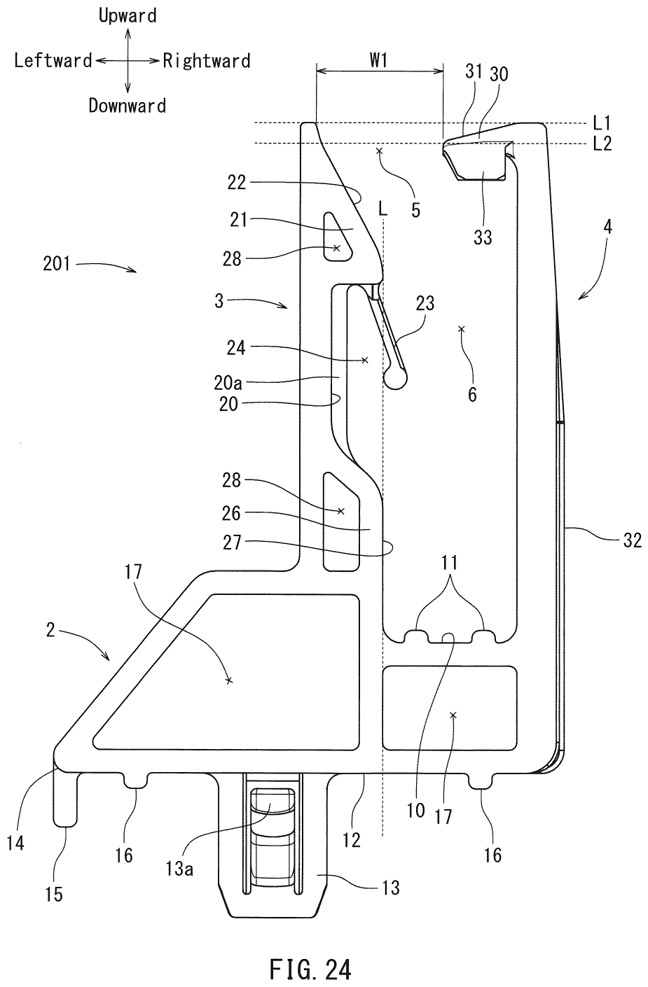

Next, a third embodiment will be described in detail with reference to FIG. 24. Because the third embodiment relates to the first embodiment, only the constructions and elements that are different from the first embodiment will be explained in detail. Elements that are the same in the first and third embodiments will be identified by the same reference numerals and a detailed description of such elements may be omitted or simplified.

The third embodiment is directed to a clip 201. Similar to the clip 1 of the first embodiment, the clip 201 is used for attaching the bus bar 7 (not shown in FIG. 24) to the vehicle body. However, the clip 201 according to the third embodiment is different from the clip 1 of the first embodiment in that the guide strip 25 projecting from the guide portion 21 formed in the first side wall 3 is omitted. Therefore, in this embodiment, the guide portion 21 is configured such that its upper end surface may define the upper end of the first side wall 3. As a result, in this embodiment, the elastic strip 23 formed in the lower end of the guide portion 21 is configured to press a portion of an upper half of the bus bar 7.

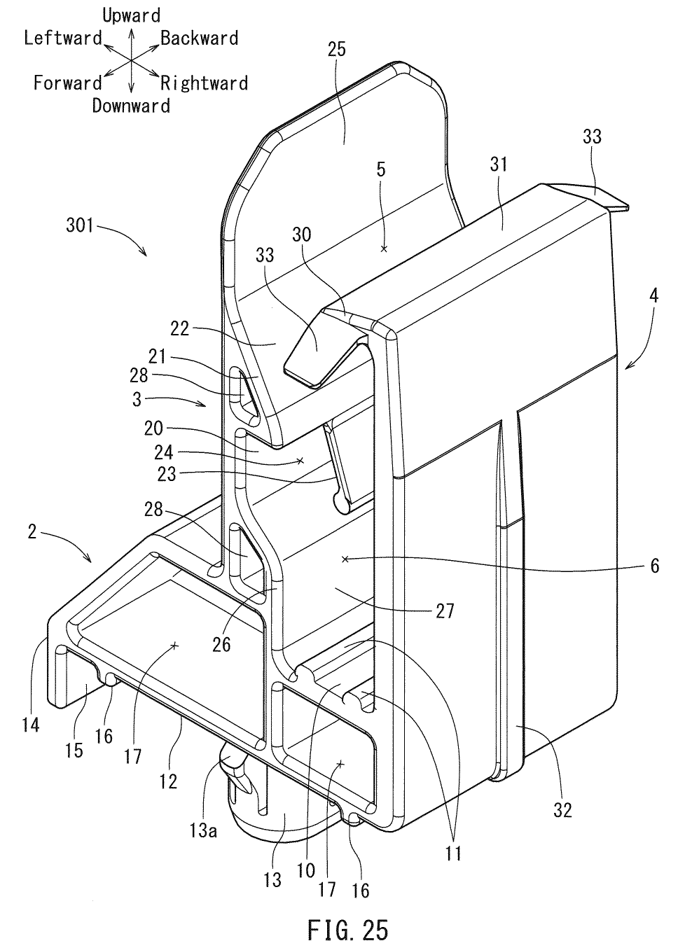

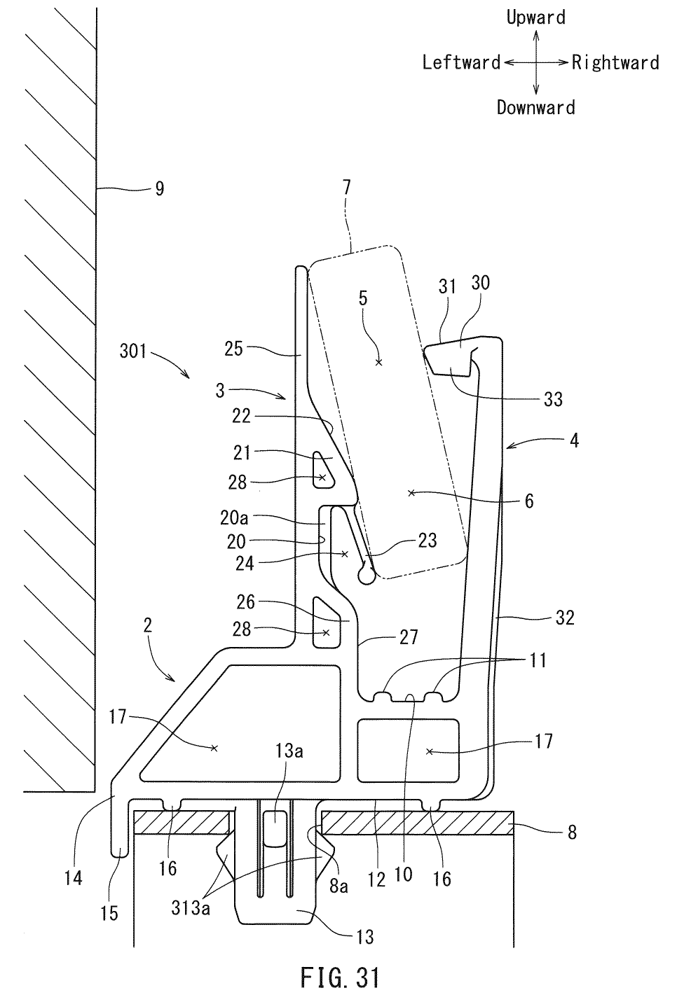

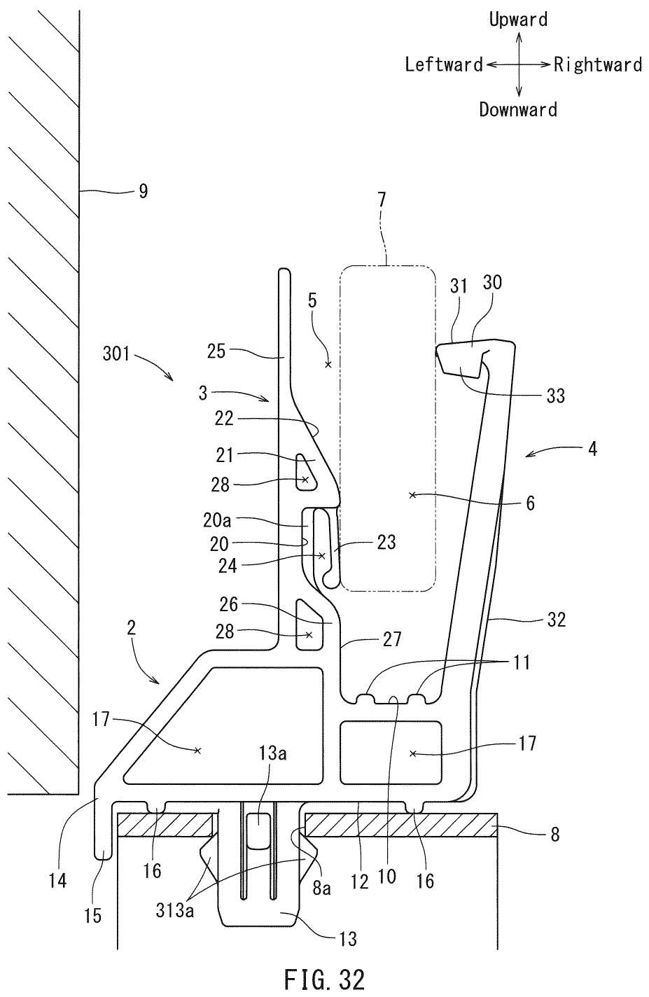

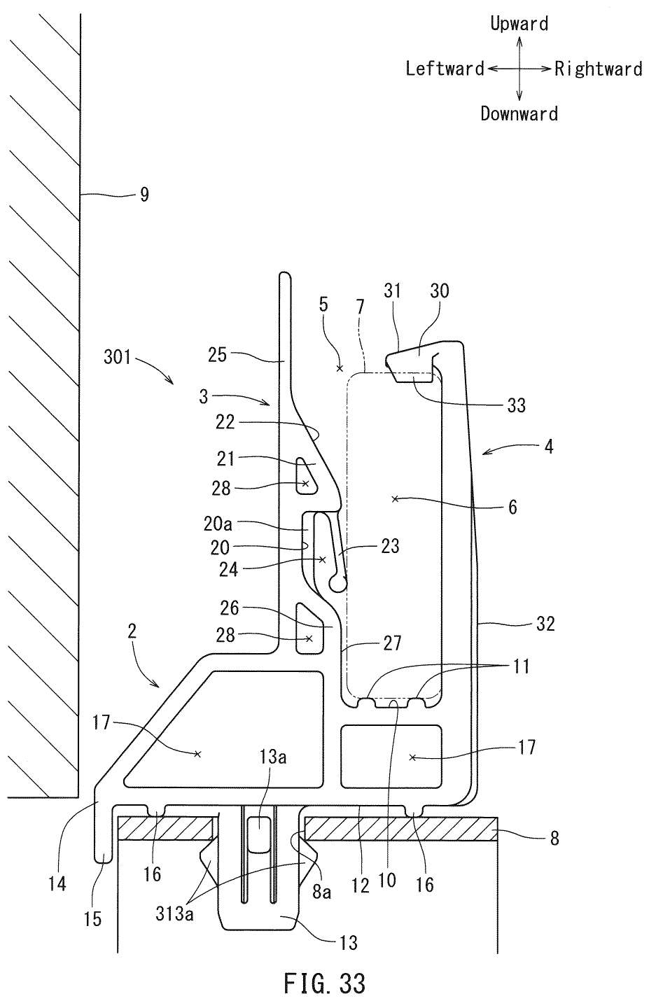

Next, a fourth embodiment will be described in detail with reference to FIGS. 25 to 33. Because the fourth embodiment relates to the first embodiment, only the constructions and elements that are different from the first embodiment will be explained in detail. Elements that are the same in the first and fourth embodiments will be identified by the same reference numerals and a detailed description of such elements may be omitted or simplified.

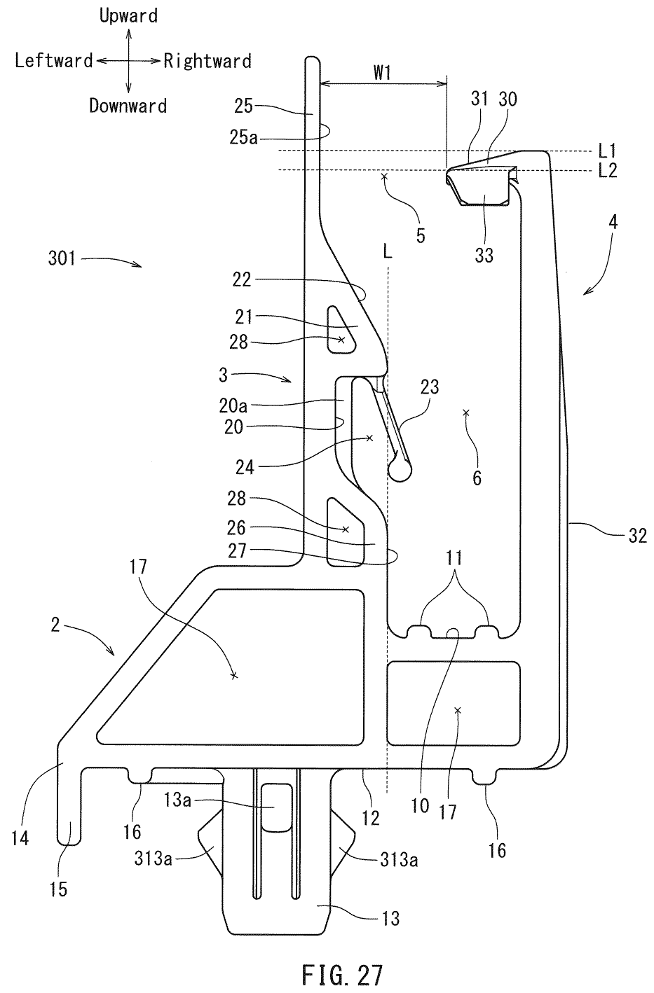

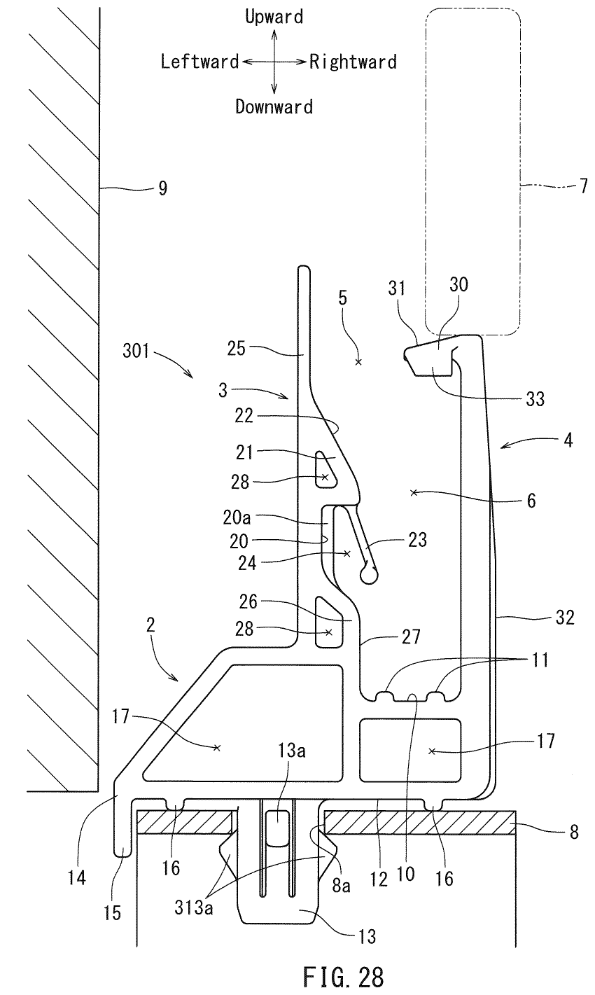

The fourth embodiment is directed to a clip 301. Similar to the clip 1 of the first embodiment, the clip 301 is used for attaching the bus bar 7 (FIGS. 28 to 33) to the vehicle body. However, as shown in FIG. 27, the clip 301 according to the fourth embodiment is different from the clip 1 of the first embodiment in that the guide strip 25 projecting from the guide portion 21 is elongated upward such that the upper end surface thereof (i.e., the upper end of the first side wall 3) is positioned above the upper end of the second side wall 4. That is, the guide strip 25 is elongated upward so as to extend beyond the bus bar retainer strip 30 formed in the upper end of the second side wall 4.

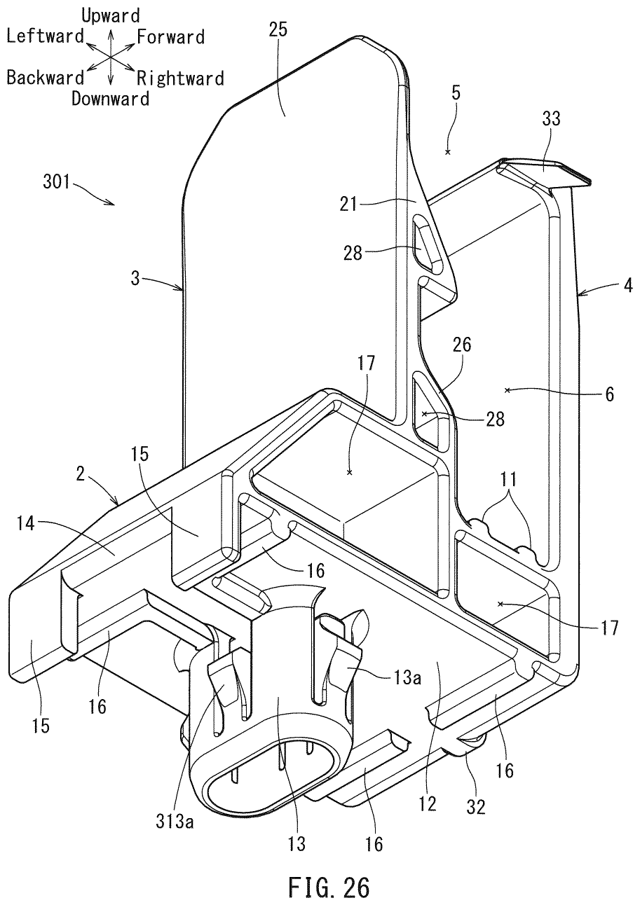

Further, as shown in FIGS. 26 and 27, in the clip 301, the engagement leg 13 has a pair of additional engagement strips 313a in addition to the engagement strips 13a. The pair of additional engagement strips 313a are formed in the engagement leg 13 so as to be oppositely positioned in a lateral direction. Similar to the engagement strips 13a, the engagement strips 313a are configured to engage the engagement hole 8a of the attachment bracket 8. Thus, according to this embodiment, the base 2 (the clip 301) can be securely connected to the attachment bracket 8 because the engagement strips 13a and the additional engagement strips 313a engage the engagement hole 8a. Further, as shown in FIG. 26, in this embodiment, the vertical projection 15 formed in the lower surface 12 of the base 2 is divided into two halves in the front-back direction. Similarly, each of the lower ribs 16 formed in the base 2 is divided into two halves in the front-back direction. Such formation of the vertical projection 15 and the lower ribs 16 may contribute to ease of molding of the clip 301 of which the engagement leg 13 includes the additional engagement strips 313a.

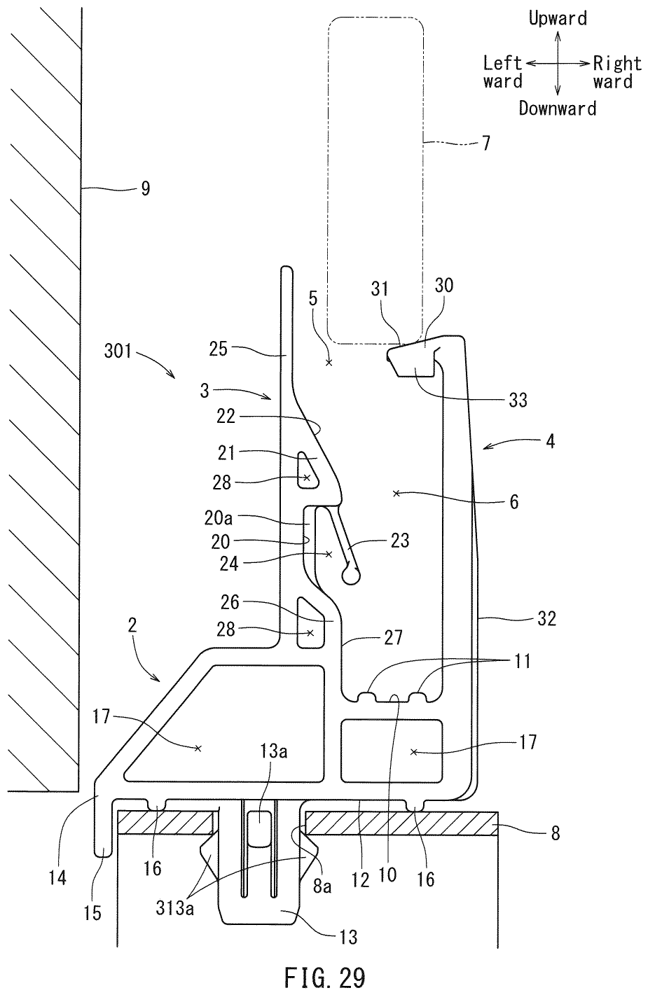

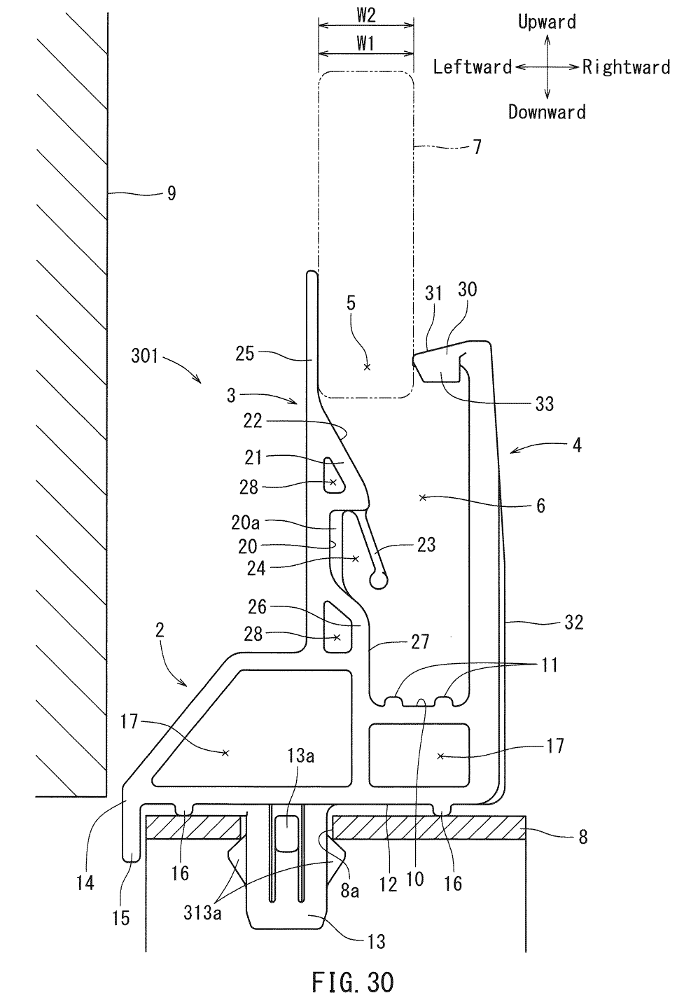

As shown in FIGS. 28 to 33, according to this embodiment, the bus bar 7 can be attached to the (two) attachment brackets 8 using the (two) clips 1 in the same manner as the first embodiment (FIGS. 7 to 13). In particular, when the bus bar 7 is pressed downward in a condition in which the bus bar 7 is positioned on the upper surface 31 of the bus bar retainer strip 30 of the second side wall 4 of each of the clips 301 (FIG. 29), the bus bar 7 may be partially introduced into the receiving space 6 through the upper opening portion 5 while contacting the guide strip 25 of the first side wall 3 of each of the clips 301 (FIG. 30). As previously described, in this embodiment, the guide strip 25 is elongated upward. Therefore, the bus bar 7 may be reliably guided by the guide portion 25 toward the receiving space 6.

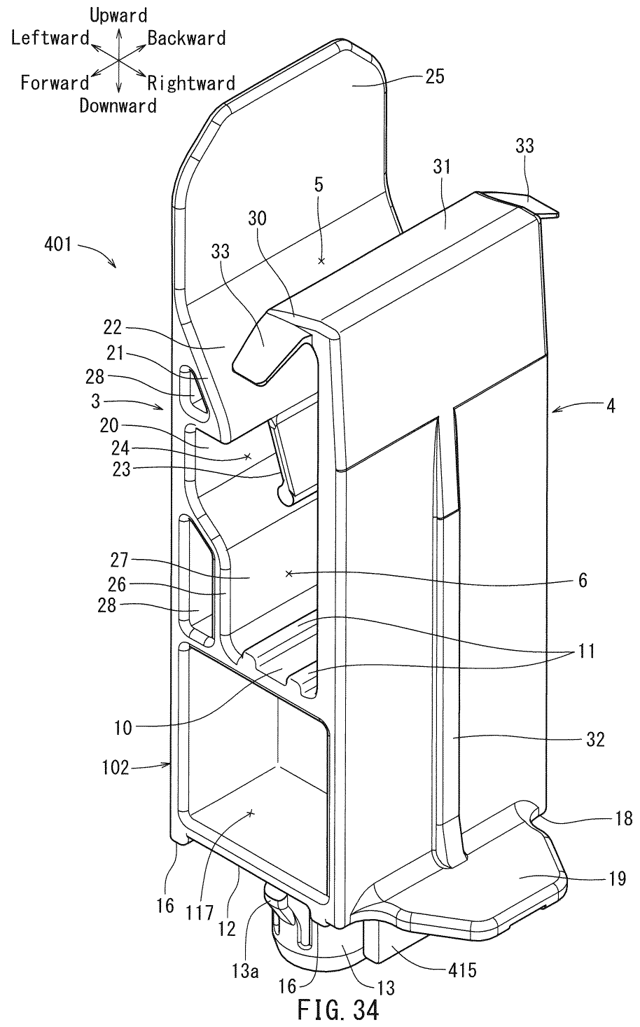

Next, a fifth embodiment will be described in detail with reference to FIGS. 34 to 36. Because the fifth embodiment relates to the second embodiment, only the constructions and elements that are different from the second embodiment will be explained in detail. Elements that are the same in the second and fifth embodiments will be identified by the same reference numerals and a detailed description of such elements may be omitted or simplified.

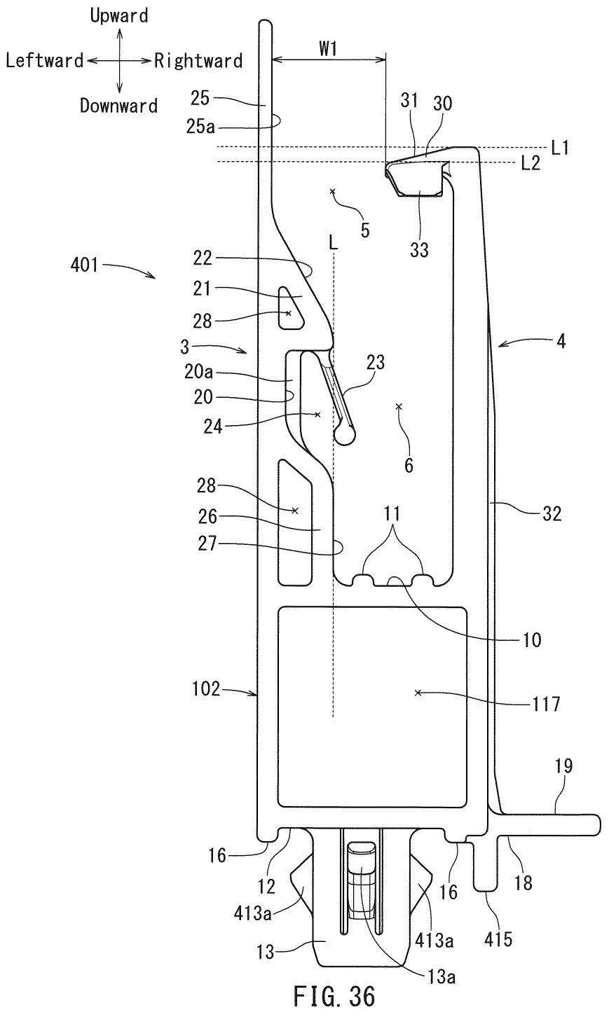

The fifth embodiment is directed to a clip 401. Similar to the clip 101 of the second embodiment, the clip 401 is used for attaching the bus bar 7 (not shown in FIGS. 34 to 36) to the vehicle body. However, as shown in FIG. 36, the clip 401 according to the fifth embodiment is different from the clip 101 of the second embodiment in that the guide strip 25 projecting from the guide portion 21 is elongated upward such that the upper end surface thereof (i.e., the upper end of the first side wall 3) is positioned above the upper end of the second side wall 4.

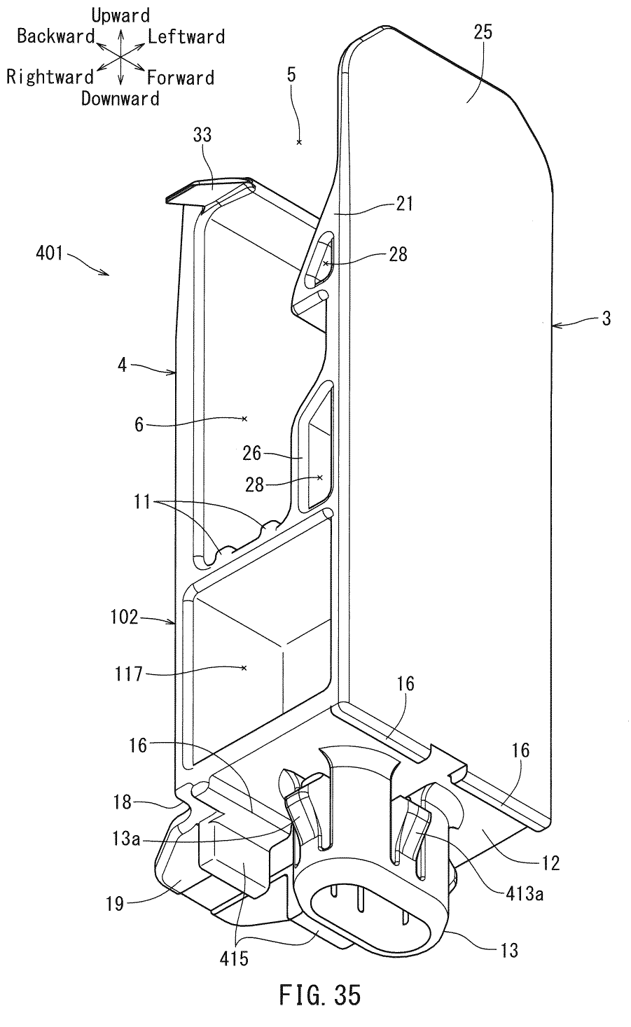

Further, as shown in FIGS. 35 and 36, in the clip 401, the engagement leg 13 has a pair of additional engagement strips 413a in addition to the engagement strips 13a. The pair of additional engagement strips 413a are formed in the engagement leg 13 so as to be oppositely positioned in the lateral direction. Similar to the engagement strips 13a, the engagement strips 413a are configured to engage the engagement hole 8a of the attachment bracket 8. Thus, according to this embodiment, the base 102 (the clip 401) can be securely connected to the attachment bracket 8 because the engagement strips 13a and the additional engagement strips 413a engage the engagement hole 8a.

As shown in FIGS. 34 to 36, the clip 401 additionally includes a vertical projection 415. The projection 415 is formed in the right lower end periphery 18 of the base 102. The projection 415 is configured to interfere with the attachment bracket 8 when the clip 401 is not properly positioned on the attachment bracket 8. Thus, the projection 415 may contribute to ease of proper positioning of the clip 401 together with the subsidiary plate 19.

Further, as shown in FIG. 35, the vertical projection 415 is divided into two halves in the front-back direction. Similarly, each of the lower ribs 16 formed in the base 102 is divided into two halves in the front-back direction. Such formation of the vertical projection 415 and the lower ribs 16 may contribute to ease of molding of the clip 401 of which the engagement leg 13 includes the additional engagement strips 413a.

The clip 401 may be used in the same manner as the clip 101. However, in the clip 401, the guide strip 25 is elongated upward relative to the guide strip 25 of the clip 101. Therefore, according to the clip 401, the bus bar 7 may be reliably guided by the guide portion 25 toward the receiving space 6 relative to the lip 101.

Naturally, various changes and modifications may be made to the first to fifth embodiments. For example, in the embodiments, the bus bar 7 has the rectangular shape in cross section. However, the bus bar 7 may have various shapes other than the rectangular shape, e.g., an elliptical shape. Further, the bus bar 7 may have an insulating coating.

Further, in the embodiments, the engagement leg 13 is formed in the lower surface 12 of the base 2 or base 102. However, the engagement leg 13 may be formed in various portions of the base 2 or base 102 as necessary. Further, the engagement leg 13 may be variously changed in structure.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A clip configured to hold an elongated conductor bar, comprising:
a structurally rigidified base;
a first side wall and a second side wall vertically extending upward from the base and having an upper opening that is configured to allow the conductor bar to pass therethrough;
a receiving space defined by the base, the first side wall and the second side wall and configured to hold the conductor bar therein; and
a retainer strip formed in an upper end of the second side wall and configured to engage an upper surface of the conductor bar held in the receiving space,
wherein the first side wall is configured to have rigidity,
wherein the second side wall is configured to elastically deform in a direction away from the first side wall,
wherein the first side wall includes a guide portion formed in an inner surface thereof and having an inclined surface that is configured to obliquely guide the conductor bar passing through the upper opening to the receiving space,
wherein the guide portion includes an elastic strip formed in a lower end periphery thereof and configured to press the conductor bar held in the receiving space against the second side wall, and
wherein the retainer strip projects into the upper opening, thereby defining an upper opening portion in the upper opening.

2. The clip as described in claim 1, wherein the first side wall includes a guide strip projecting upward from the guide portion and configured such that its upper end surface is positioned above the retainer strip.

3. The clip as described in claim 1, wherein the retainer strip includes an upper surface inclined downward from the upper end of the second side wall toward the first side wall.

4. A clip as described in claim 1, wherein the upper opening portion is configured to have a width substantially equal to a thickness of the conductor bar.

5. The clip as described in claim 1, wherein the elastic strip is configured to press a portion of a lower half of the bus bar held in the receiving space.

6. The clip as described in claim 1, wherein the second side wall is configured to be reduced in thickness from its proximal end toward its distal end.

7. The clip as described in claim 1, wherein the second side wall includes a rib formed in its outer surface and extending from its proximal end toward its distal end, and wherein the rib is configured to be gradually reduced in height toward the distal end of the second side wall.

8. The clip as described in claim 1 further comprising an engagement leg configured to connect the base to an object member, and a projection formed in the base for proper positioning of the clip.

9. The clip as described in claim 1, wherein the first side wall includes a bulged portion formed in its proximal end and configured to be bulged toward the second side wall, and wherein the bulged portion is configured such that a bulging surface thereof is vertically aligned with a lower end of the inclined surface of the guide portion.

10. The clip as described in claim 9, wherein the first side wall includes a clearance formed therein and configured to allow the elastic strip to flex toward the first side wall.
